(19) United States
(12) Patent Application Publication
(10) Pub. No.: US 2019/0375443 A1
(43) Pub. Date: Dec. 12, 2019

(54) Bucket caddy

(71) Applicants: Vincent Nicholas, Lady Lake, FL (US); Barry Wiser, Lady Lake, FL (US)

(72) Inventors: Vincent Nicholas, Lady Lake, FL (US); Barry Wiser, Lady Lake, FL (US)

(21) Appl. No.: 16/433,582

(22) Filed: Jun. 6, 2019

Related U.S. Application Data
(60) Provisional application No. 62/682,889, filed on Jun. 9, 2018.

(51) Int. Cl. B62B 3/04; B62B 3/08

(52) U.S. Cl. CPC B62B 3/04; B62B 2301/04; B62B 3/08

(57) ABSTRACT

Disclosed herein is a bucket caddy comprising a U-shaped frame, a plurality of caster wheels, two vertical members and two vertical members. The U-shaped frame comprising a first horizontal member, a second horizontal member, and a third horizontal member, wherein a first end of the first horizontal member is connected to a first end of the third horizontal member and a first end of the second horizontal member is connected to a second end of the third horizontal member. The plurality of caster wheels supports the U-shaped frame. The two vertical members comprising a first vertical member and a second vertical member, wherein the lower end of each the first vertical member and the second vertical member is attached to the first horizontal member and the second horizontal member respectively. The bucket holder is secured to the two vertical members via two removable pivots and two cotter pins.

### RELATED APPLICATION(S)

Under provisions of 35 U.S.C. § 119e, the Applicant(s) claim the benefit of U.S. provisional application No. 62/682,889, filed on 9 Jun. 2018, which is incorporated herein by reference.

### FIELD OF THE INVENTION

Generally, the present disclosure relates to the field of tools and accessories. More specifically, the present disclosure relates to a bucket caddy.

### BACKGROUND

Laying ceramic tile on a floor is a difficult task, particularly when spreading thinset mortar. Further, spreading the proper amount of thinset mortar is a slow, tedious task and often results in wastage of thinset mortar. Furthermore, the bucket of the thinset mortar is very heavy and difficult to handle.

Therefore, there is a need for an improved device which steadily supports the bucket of thinset mortar in a pouring position that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a bucket caddy comprising a U-shaped frame, a plurality of caster wheels, two vertical members and two vertical members. The U-shaped frame comprising a first horizontal member, a second horizontal member, and a third horizontal member. Further, a first end of the first horizontal member is connected to a first end of the third horizontal member and a first end of the second horizontal member is connected to a second end of the third horizontal member. Further, the plurality of caster wheels supporting the U-shaped frame. Further, the two vertical members comprising a first vertical member and a second vertical member, wherein the lower end of each the first vertical member and the second vertical member is attached to the first horizontal member and the second horizontal member respectively. Further, the bucket holder secured to the upper ends of the two vertical members via two removable pivots and two cotter pins.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side view of a bucket caddy, in accordance with an exemplary embodiment.

FIG. 2 is a front view of the bucket caddy, in accordance with an exemplary embodiment.

FIG. 3 is a top front perspective view of the bucket caddy, in accordance with an exemplary embodiment.

FIG. 4 is a top rear perspective view of the bucket caddy, in accordance with an exemplary embodiment.

FIG. 5 is a left side view of the bucket caddy with a bucket holder in the tipped position, in accordance with an exemplary embodiment.

FIG. 6 is a front view of the bucket caddy with the bucket holder in the tipped position, in accordance with an exemplary embodiment.

FIG. 7 is a top front perspective view of the bucket caddy with the bucket holder in the tipped position, in accordance with an exemplary embodiment.

FIG. 8 is a top rear perspective view of the bucket caddy with the bucket holder in the tipped position, in accordance with an exemplary embodiment.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of bucket caddy, embodiments of the present disclosure are not limited to use only in this context.

According to some embodiments, a thinset bucket caddy is disclosed. The thinset bucket caddy provides a pivoting bucket holder which may be used to pour thinset mortar on a floor, supported by a U-shaped frame and two vertical members manufactured from tubular steel or aluminum alloy. The bucket holder is secured to the upper ends of the vertical members with removable pivots and cotter pins. The thinset bucket caddy steadily supports the bucket in a pouring position.

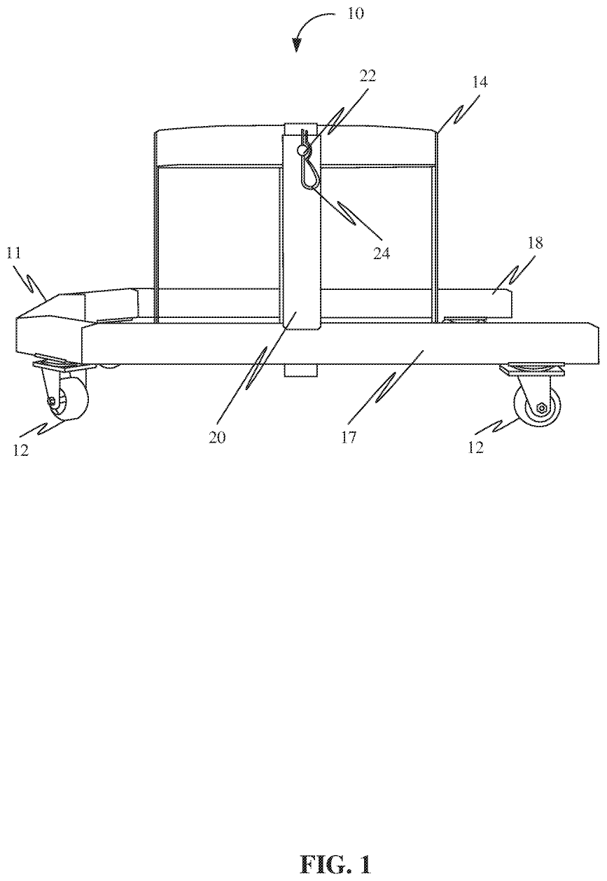

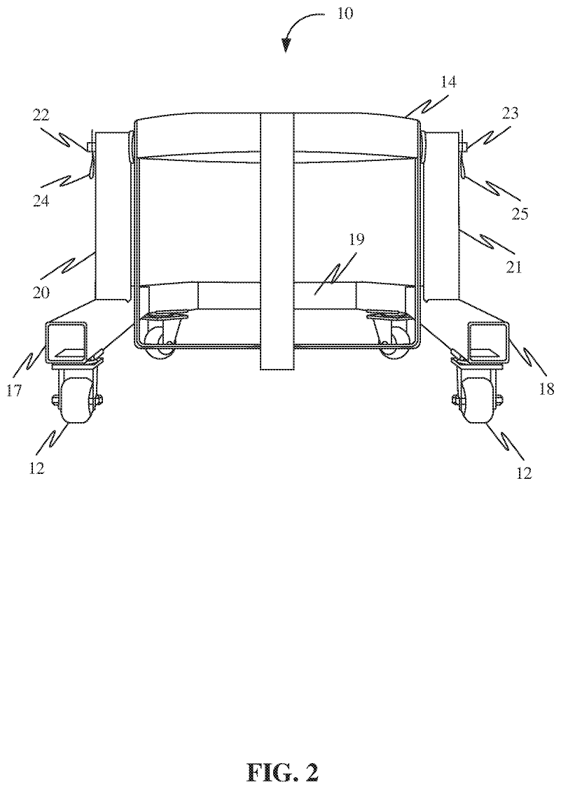

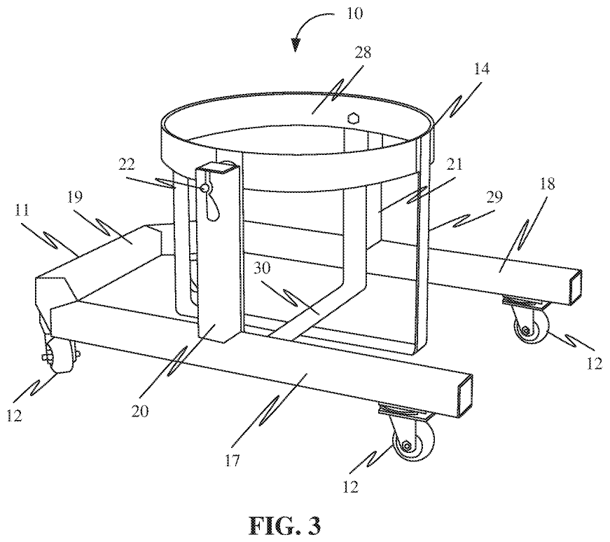

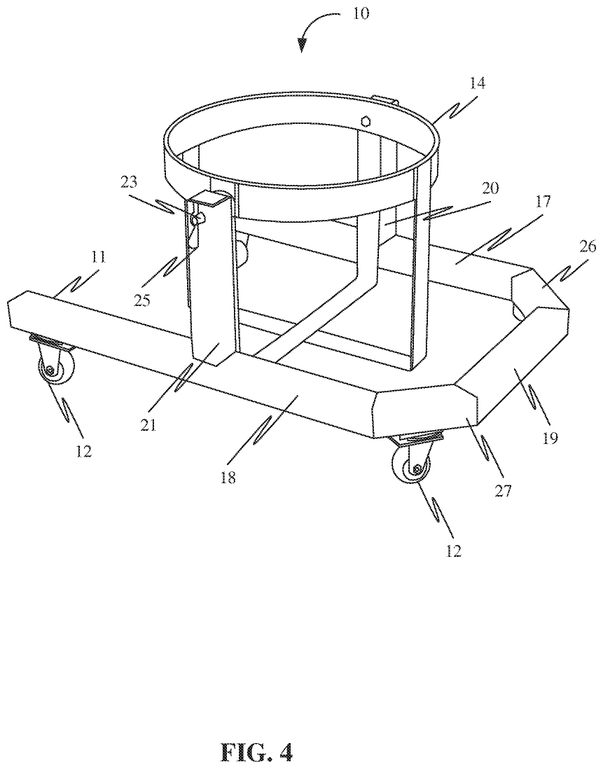

Referring now to figures, FIG. 1 is a left side view of a bucket caddy 10, in accordance with an exemplary embodiment. FIG. 2 is a front view of the bucket caddy 10. FIG. 3 is a top front perspective view of the bucket caddy 10. FIG. 4 is a top rear perspective view of the bucket caddy 10.

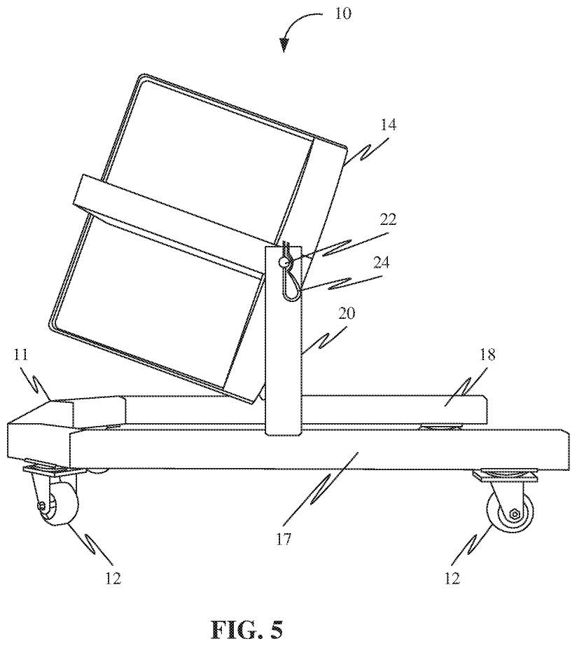

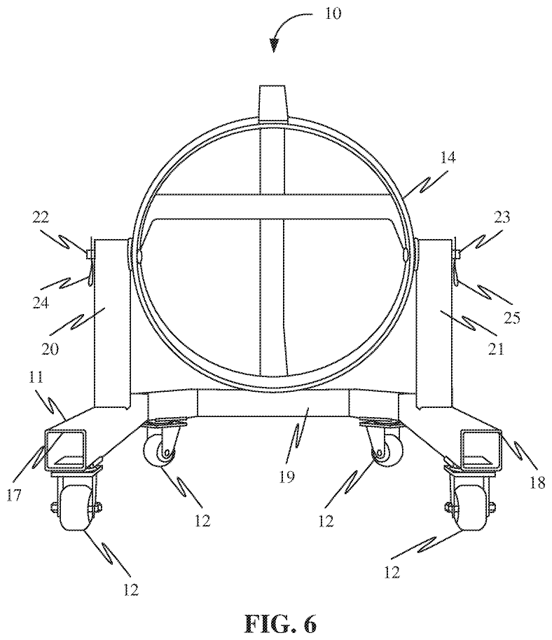

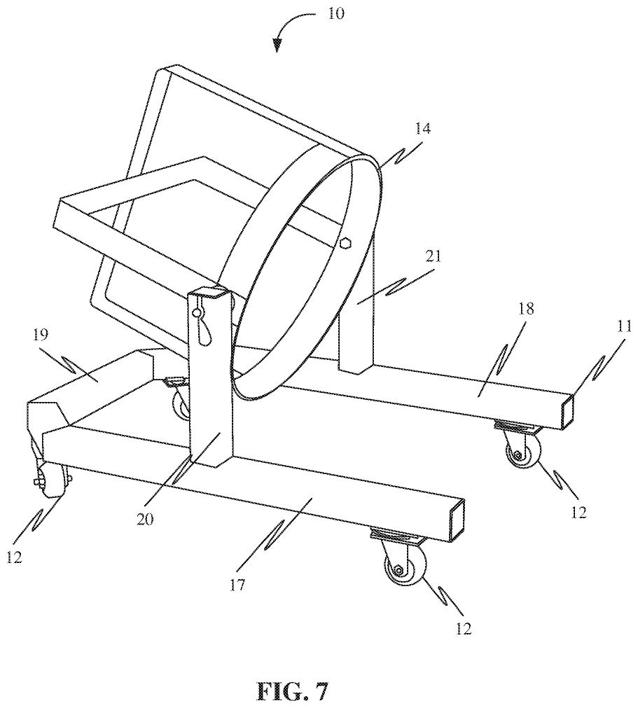

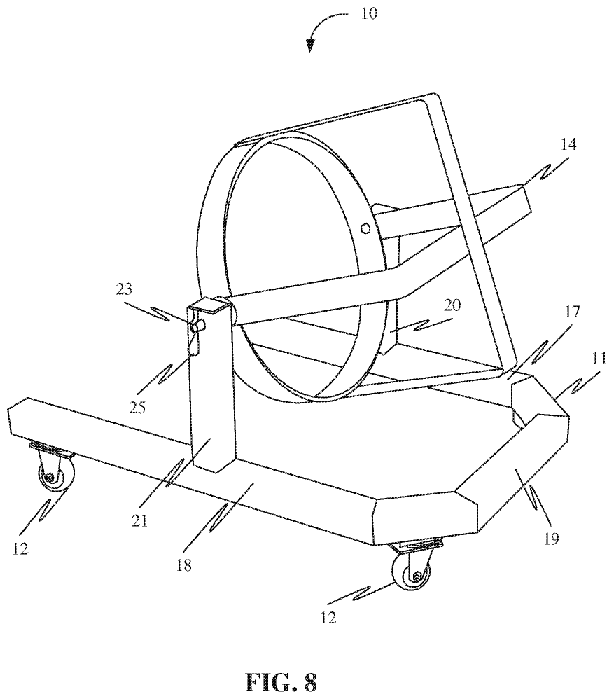

FIG. 5 is a left side view of the bucket caddy 10 with a bucket holder 14 in the tipped position, in accordance with an exemplary embodiment. FIG. 6 is a front view of the bucket caddy 10 with the bucket holder 14 in the tipped position. FIG. 7 is a top front perspective view of the bucket caddy 10 with the bucket holder 14. FIG. 8 is a top rear perspective view of the bucket caddy 10 with the bucket holder 14 in the tipped position.

The bucket caddy 10 comprises a U-shaped frame 11, a plurality of caster wheels 12, two vertical members and the bucket holder 14.

The U-shaped frame 11 may comprise a first horizontal member 17, a second horizontal member 18 and a third horizontal member 19. Further, a first end of the first horizontal member 17 is connected to a first end of the third horizontal member 19. Further, a first end of the second horizontal member 18 is connected to a second end of the third horizontal member 19.

In an embodiment, at least one of the first horizontal member 17, the second horizontal member 18, and the third horizontal member 19 may be a hollow pipe. Further, the shape of the cross-section of the hollow pipe may be at least one of a circular shape and a rectangular shape.

In an embodiment, the first end of the first horizontal member 17 is connected to the first end of the third horizontal member 19 via a fourth horizontal member 26 as shown in FIG. 4.

In an embodiment, the first end of the second horizontal member 18 is connected to the second end of the third horizontal member 19 via a fifth horizontal member 27 as shown in FIG. 4.

The plurality of caster wheels 12 support the U-shaped frame 11. In an embodiment, the plurality of caster wheels 12 comprises four caster wheels.

The two vertical members comprising a first vertical member 20 and a second vertical member 21, wherein the lower end of each the first vertical member 20 and the second vertical member 21 is attached to the first horizontal member 17 and the second horizontal member 18 respectively. In an embodiment, at least one of the first vertical member 20 and the second vertical member 21 may be a hollow pipe. Further, the shape of the cross-section of the hollow pipe may be at least one of a circular shape and a rectangular shape.

The bucket holder 14 is secured to the upper ends of the two vertical members 20-21 via two removable pivots 22-23 and two cotter pins 24-25 respectively.

In an embodiment, the bucket holder 14 may include a top rim 28 and two U-shaped strips 29-30 as shown in FIG. 3. Further, the two ends of each of the two U-shaped strips 29-30 may be attached to the top rim 28 to create an enclosure for a bucket as shown in FIG. 3. The enclosure may have a cylindrical shape.

In an embodiment, the size of the bucket holder 14 may correspond to a bucket filled with thinset mortar. The bucket may be placed in the enclosure formed by the two U-shaped strips 29-30. Further, the bucket holder 14 may be configured to pivot on the two removable pivots 22-23 for pouring the thinset mortar in the bucket on a floor

According to some embodiments, the bucket caddy 10 may be configured in much the same manner as a janitor's mop bucket. Further, the bucket caddy 10 may be used to pour thinset mortar on a floor, by tipping the bucket holder 14 toward the open front end of the U-shaped frame 11 as shown in FIGS. 5-8.

To use the bucket caddy 10, a user may place a bucket filled with thinset mortar in the bucket holder 14. The user may then roll the bucket caddy 10 to a preferred location on the plurality of the caster wheels 12, and pour the thinset mortar by carefully tipping the bucket holder 14, then returning the bucket holder 14 to the upright position.

Further, at least one of the U-shaped frame 11, the two vertical members 20-21, the bucket holder 14, the two removable pivots 22-23 and the two cotter pins 24-25 is made of at least one of steel, aluminum alloy, and plastic.

Further, at least one of the U-shaped frame 11, the two vertical members 20-21, the bucket holder 14, the two removable pivots 22-23 and the two cotter pins 24-25 may be manufactured from rigid, durable materials. The plurality of the caster wheels 12 may be manufactured from a flexible, durable material such as rubber, mounted in yokes which may be manufactured from a rigid, durable material, such as steel or aluminum alloy. The bucket holder 14, the pivots 22-23, and the cotter pins 24-25 may be manufactured from a rigid, durable material, such as steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

Although the present disclosure has been explained in relation to its preferred embodiment, it is to be understood that many other possible modifications and variations can be made without departing from the spirit and scope of the disclosure.

What is claimed is:

1. A bucket caddy comprising:
a U-shaped frame comprising a first horizontal member, a second horizontal member, and a third horizontal member, wherein a first end of the first horizontal member is connected to a first end of the third horizontal member and a first end of the second horizontal member is connected to a second end of the third horizontal member;
a plurality of caster wheels supporting the U-shaped frame;
two vertical members comprising a first vertical member and a second vertical member, wherein the lower end of each the first vertical member and the second vertical member is attached to the first horizontal member and the second horizontal member respectively;
a bucket holder secured to the upper ends of the two vertical members via two removable pivots and two cotter pins.

2. The bucket caddy of claim 1 wherein the plurality of caster wheels comprises four caster wheels.

3. The bucket caddy of claim 1 wherein the bucket holder comprises a top rim and two U-shaped strips, wherein the two ends of each of the two U-shaped strips are attached to the top rim to create an enclosure for a bucket.

4. The bucket caddy of claim 1 wherein at least one of the first horizontal member, the second horizontal member, and the third horizontal member is a hollow pipe.

5. The bucket caddy of claim 4 wherein the shape of the cross-section of the hollow pipe is at least one of a circular shape and a rectangular shape.

6. The bucket caddy of claim 1 wherein the first end of the first horizontal member is connected to the first end of the third horizontal member via a fourth horizontal member.

7. The bucket caddy of claim 1 wherein the first end of the second horizontal member is connected to the second end of the third horizontal member via a fifth horizontal member.

8. The bucket caddy of claim 1 wherein at least one of the first vertical member and the second vertical member is a hollow pipe.

9. The bucket caddy of claim 8 wherein the shape of the cross-section of the hollow pipe is at least one of a circular shape and a rectangular shape.

10. The bucket caddy of claim 1 wherein at least one of the U-shaped frame, the two vertical members, the bucket holder, the two removable pivots and the two cotter pins is made of at least one of steel, aluminum alloy and plastic.

11. The bucket caddy of claim 1 wherein the size of the bucket holder corresponds to a bucket filled with thinset mortar.

12. The bucket caddy of claim 11 wherein the bucket holder is configured to pivot on the two removable pivots for pouring the thinset mortar in the bucket on a floor.
